(19) United States
(12) Patent Application Publication
(10) Pub. No.: US 2020/0218310 A1
(43) Pub. Date: Jul. 9, 2020

(54) METHOD FOR CONTROLLING POWER BACK OFF USING GRIP SENSOR AND ELECTRONIC DEVICE FOR SUPPORTING THE SAME

(71) Applicant: Samsung Electronics Co., Ltd., Suwon-si (KR)

(72) Inventors: Minjeong KIM, Suwon-si (KR); Hojong KIM, Suwon-si (KR)

(21) Appl. No.: 16/736,054

(22) Filed: Jan. 7, 2020

(30) Foreign Application Priority Data
Jan. 7, 2019 (KR) 10-2019-0001797

(51) Int. Cl. G06F 1/16; H02J 50/20; H01Q 1/24; H01Q 1/46

(52) U.S. Cl. CPC G06F 1/169; H01Q 1/46; H01Q 1/243; H02J 50/20

(57) ABSTRACT

An electronic device is provided. The electronic device includes a communication circuit, a grip sensor, and at least one processor, wherein the at least one processor is configured to obtain a sensing signal generated in the grip sensor, detect that the electronic device is coupled to an external electronic device via the communication circuit, identify whether a strength of the sensing signal corresponds to a designated signal range, upon detecting that the electronic device is coupled to the external electronic device, and maintain a maximum power intensity of a radio signal to be transmitted via the communication circuit, in response that the strength of the sensing signal corresponds to the designated signal range.

### CROSS-REFERENCE TO RELATED APPLICATION(S)

This application is based on and claims priority under 35 U.S.C. § 119(a) of a Korean patent application number 10-2019-0001797, filed on Jan. 7, 2019, in the Korean Intellectual Property Office, the disclosure of which is incorporated by reference herein in its entirety.

### BACKGROUND

### 1. Field

The disclosure relates to a method for controlling power back off using a grip sensor, and an electronic device supporting the method.

### 2. Description of Related Art

A Specific Absorption Rate (SAR) refers to an amount of energy per unit mass for electromagnetic waves generated from an electronic device and absorbed by a human body. If a measurement value of the SAR is great during the electronic device is used, it may adversely affect the human body. Each country regulates the SAR for the human body not to exceed a reference value.

A grip sensor may sense that an external object (e.g., a human body) is in proximity to or in contact with an electronic device. Upon receiving information on the proximity or contact of the external object from the grip sensor, the electronic device may satisfy an SAR standard by decreasing maximum power of a radio signal to be transmitted to be less than or equal to a designated value.

However, in the technique of the related art, the electronic device may cannot identify whether an external object which is in proximity to or in contact with the electronic device is a human body or an object (e.g., a wireless charging device) other than the human body by using the grip sensor. Accordingly, even if the object other than the human body is in proximity to or in contact with the electronic device, an operation of decreasing the maximum power of the radio signal to be transmitted to be less than or equal to the designated value is performed, thereby deteriorating communication performance of the electronic device.

Various embodiments of the disclosure relate to a method for controlling power back off using a grip sensor capable of avoiding deterioration of communication performance by maintaining maximum power of a radio signal to be transmitted when a designated condition is satisfied, and an electronic device supporting the method.

The above information is presented as background information only to assist with an understanding the disclosure. No determination has been made, and no assertion is made, as to whether any of the above might be applicable as prior art with regard the disclosure.

### SUMMARY

Aspects of the disclosure are to address at least the above-mentioned problems and/or disadvantages and to provide at least the advantages described below. Accordingly, an aspect of the disclosure is to provide a method for controlling power back off using a grip sensor, and an electronic device supporting the method.

Additional aspects will be set forth in part in the description which follows and, in part, will be apparent from the description, or may be learned by practice of the presented embodiments.

In accordance with an aspect of the disclosure, an electronic device is provided. The electronic device includes a communication circuit, a grip sensor, and at least one processor. The at least one processor may be configured to obtain a sensing signal generated in the grip sensor, detect that the electronic device is coupled to an external electronic device via the communication circuit, identify whether a strength of the sensing signal corresponds to a designated signal range, upon detecting that the electronic device is coupled to the external electronic device, and maintain a maximum power intensity of a radio signal to be transmitted via the communication circuit, in response that the strength of the sensing signal corresponds to the designated signal range.

In accordance with another aspect of the disclosure, a method is provided. The method includes obtaining a sensing signal generated in a grip sensor, detecting that an electronic device is coupled to an external electronic device via a communication circuit, identifying whether a strength of the sensing signal corresponds to a designated signal range, upon detecting that the electronic device is coupled to the external electronic device, and maintaining a maximum power intensity of a radio signal to be transmitted via the communication circuit, in response that the strength of the sensing signal corresponds to the designated signal range.

In accordance with another aspect of the disclosure, an electronic device is provided. The electronic device includes a communication circuit, a grip sensor, and at least one processor. The at least one processor may be configured to obtain a sensing signal generated in a grip sensor, identify whether a strength of the sensing signal corresponds to a designated signal range, and maintain a maximum power intensity of a radio signal to be transmitted via the communication circuit, in response that the strength of the sensing signal corresponds to the designated signal range.

In accordance with another aspect of the disclosure, an electronic device is provided. The electronic device includes a communication circuit, a grip sensor, and at least one processor. The at least one processor may be configured to obtain a sensing signal generated in the grip sensor, detect that the electronic device is coupled to an external electronic device via the communication circuit, and stop an operation of the grip sensor and maintain maximum power intensity of a radio signal to be transmitted via the communication circuit, in response to detecting that the electronic device is coupled to the external electronic device.

In accordance with another aspect of the disclosure, a method for controlling power back off using a grip sensor and an electronic device supporting the method is provided. The method can avoid deterioration of communication performance by maintaining maximum power of a radio signal to be transmitted when a designated condition is satisfied.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 is a block diagram of an electronic device according to an embodiment of the disclosure;

FIG. 3 is a drawing illustrating a grip sensor and a structure of an electronic device related to the grip sensor according to an embodiment of the disclosure;

FIG. 4 is a diagram illustrating a sensing signal obtained depending on a human body or an external electronic device according to an embodiment of the disclosure;

FIG. 5 is a flowchart illustrating a method for controlling power back off using a grip sensor according to an embodiment of the disclosure;

FIG. 6 is a flowchart illustrating a method for controlling power back off using a grip sensor, based on an external electronic device coupled to an electronic device according to an embodiment of the disclosure;

FIG. 7 is a flowchart illustrating a method for controlling power back off using a grip sensor, based on a designated signal range corresponding to an external electronic device, according to an embodiment of the disclosure;

FIG. 8 is a flowchart illustrating a method for controlling an operation of a grip sensor according to an embodiment of the disclosure;

FIG. 9 is a flowchart illustrating a method for controlling power back off using a grip sensor based on a proximity or contact of an external object according to an embodiment of the disclosure; and

FIG. 10 is a flowchart illustrating a method for controlling power back off using a grip sensor based on a proximity or contact of an external object according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

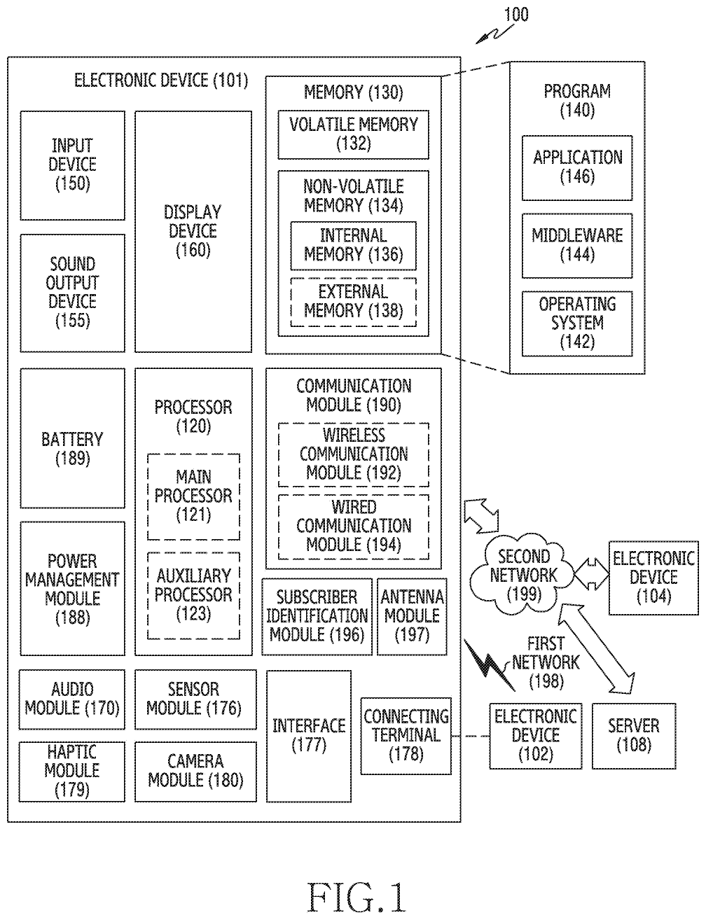

FIG. 1 is a block diagram illustrating an electronic device in a network environment according to an embodiment of the disclosure.

Referring to FIG. 1, an electronic device (101) in a network environment (100) may communicate with an electronic device (102) via a first network (198) (e.g., a short-range wireless communication network), or an electronic device (104) or a server (108) via a second network (199) (e.g., a long-range wireless communication network). According to an embodiment, the electronic device (101) may communicate with the electronic device (104) via the server (108). According to an embodiment, the electronic device (101) may include a processor (120), memory (130), an input device (150), a sound output device (155), a display device (160), an audio module (170), a sensor module (176), an interface (177), a haptic module (179), a camera module (180), a power management module (188), a battery (189), a communication module (190), a subscriber identification module (SIM) (196), or an antenna module (197). In some embodiments, at least one (e.g., the display device (160) or the camera module (180)) of the components may be omitted from the electronic device (101), or one or more other components may be added in the electronic device (101). In some embodiments, some of the components may be implemented as single integrated circuitry. For example, the sensor module (176) (e.g., a fingerprint sensor, an iris sensor, or an illuminance sensor) may be implemented as embedded in the display device (160) (e.g., a display).

The processor (120) may execute, for example, software (e.g., a program (140)) to control at least one other component (e.g., a hardware or software component) of the electronic device (101) coupled with the processor (120), and may perform various data processing or computation. According to one embodiment, as at least part of the data processing or computation, the processor (120) may load a command or data received from another component (e.g., the sensor module (176) or the communication module (190)) in volatile memory (132), process the command or the data stored in the volatile memory (132), and store resulting data in non-volatile memory (134). According to an embodiment, the processor (120) may include a main processor (121) (e.g., a central processing unit (CPU) or an application processor (AP)), and an auxiliary processor (123) (e.g., a graphics processing unit (GPU), an image signal processor (ISP), a sensor hub processor, or a communication processor (CP)) that is operable independently from, or in conjunction with, the main processor (121). Additionally or alternatively, the auxiliary processor (123) may be adapted to consume less power than the main processor (121), or to be specific to a specified function. The auxiliary processor (123) may be implemented as separate from, or as part of the main processor (121).

The auxiliary processor (123) may control at least some of functions or states related to at least one component (e.g., the display device (160), the sensor module (176), or the communication module (190)) among the components of the electronic device (101), instead of the main processor (121) while the main processor (121) is in an inactive (e.g., sleep) state, or together with the main processor (121) while the main processor (121) is in an active state (e.g., executing an application). According to an embodiment, the auxiliary processor (123) (e.g., an image signal processor or a communication processor) may be implemented as part of another component (e.g., the camera module (180) or the communication module (190)) functionally related to the auxiliary processor (123).

The memory (130) may store various data used by at least one component (e.g., the processor (120) or the sensor module (176)) of the electronic device (101). The various data may include, for example, software (e.g., the program (140)) and input data or output data for a command related thererto. The memory (130) may include the volatile memory (132) or the non-volatile memory (134).

The program (140) may be stored in the memory (130) as software, and may include, for example, an operating system (OS) (142), middleware (144), or an application (146).

The input device (150) may receive a command or data to be used by other component (e.g., the processor (120)) of the electronic device (101), from the outside (e.g., a user) of the electronic device (101). The input device (150) may include, for example, a microphone, a mouse, a keyboard, or a digital pen (e.g., a stylus pen).

The sound output device (155) may output sound signals to the outside of the electronic device (101). The sound output device (155) may include, for example, a speaker or a receiver. The speaker may be used for general purposes, such as playing multimedia or playing record, and the receiver may be used for incoming calls. According to an embodiment, the receiver may be implemented as separate from, or as part of the speaker.

The display device (160) may visually provide information to the outside (e.g., a user) of the electronic device (101). The display device (160) may include, for example, a display, a hologram device, or a projector and control circuitry to control a corresponding one of the display, hologram device, and projector. According to an embodiment, the display device (160) may include touch circuitry adapted to detect a touch, or sensor circuitry (e.g., a pressure sensor) adapted to measure the intensity of force incurred by the touch.

The audio module (170) may convert a sound into an electrical signal and vice versa. According to an embodiment, the audio module (170) may obtain the sound via the input device (150), or output the sound via the sound output device (155) or a headphone of an external electronic device (e.g., an electronic device (102)) directly (e.g., wiredly) or wirelessly coupled with the electronic device (101).

The sensor module (176) may detect an operational state (e.g., power or temperature) of the electronic device (101) or an environmental state (e.g., a state of a user) external to the electronic device (101), and then generate an electrical signal or data value corresponding to the detected state. According to an embodiment, the sensor module (176) may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface (177) may support one or more specified protocols to be used for the electronic device (101) to be coupled with the external electronic device (e.g., the electronic device (102)) directly (e.g., wiredly) or wirelessly. According to an embodiment, the interface (177) may include, for example, a high definition multimedia interface (HDMI), a universal serial bus (USB) interface, a secure digital (SD) card interface, or an audio interface.

A connecting terminal (178) may include a connector via which the electronic device (101) may be physically connected with the external electronic device (e.g., the electronic device (102)). According to an embodiment, the connecting terminal (178) may include, for example, a HDMI connector, a USB connector, a SD card connector, or an audio connector (e.g., a headphone connector).

The haptic module (179) may convert an electrical signal into a mechanical stimulus (e.g., a vibration or a movement) or electrical stimulus which may be recognized by a user via his tactile sensation or kinesthetic sensation. According to an embodiment, the haptic module (179) may include, for example, a motor, a piezoelectric element, or an electric stimulator.

The camera module (180) may capture an image or moving images. According to an embodiment, the camera module (180) may include one or more lenses, image sensors, image signal processors, or flashes.

The power management module (188) may manage power supplied to the electronic device (101). According to one embodiment, the power management module (188) may be implemented as at least part of, for example, a power management integrated circuit (PMIC).

The battery (189) may supply power to at least one component of the electronic device (101). According to an embodiment, the battery (189) may include, for example, a primary cell which is not rechargeable, a secondary cell which is rechargeable, or a fuel cell.

The communication module (190) may support establishing a direct (e.g., wired) communication channel or a wireless communication channel between the electronic device (101) and the external electronic device (e.g., the electronic device (102), the electronic device (104), or the server (108)) and performing communication via the established communication channel The communication module (190) may include one or more communication processors that are operable independently from the processor (120) (e.g., the application processor (AP)) and supports a direct (e.g., wired) communication or a wireless communication. According to an embodiment, the communication module (190) may include a wireless communication module (192) (e.g., a cellular communication module, a short-range wireless communication module, or a global navigation satellite system (GNSS) communication module) or a wired communication module (194) (e.g., a local area network (LAN) communication module or a power line communication (PLC) module). A corresponding one of these communication modules may communicate with the external electronic device via the first network (198) (e.g., a short-range communication network, such as Bluetooth™, wireless-fidelity (Wi-Fi) direct, or infrared data association (IrDA)) or the second network (199) (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module (192) may identify and authenticate the electronic device (101) in a communication network, such as the first network (198) or the second network (199), using subscriber information (e.g., international mobile subscriber identity (IMSI)) stored in the subscriber identification module (196).

The antenna module (197) may transmit or receive a signal or power to or from the outside (e.g., the external electronic device) of the electronic device (101). According to an embodiment, the antenna module (197) may include a plurality of antennas. In such a case, at least one antenna appropriate for a communication scheme used in the communication network, such as the first network (198) or the second network (199), may be selected, for example, by the communication module (190) (e.g., the wireless communication module (192)) from the plurality of antennas. The signal or the power may then be transmitted or received between the communication module (190) and the external electronic device via the selected at least one antenna.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device (101) and the external electronic device (104) via the server (108) coupled with the second network (199). Each of the electronic devices (102) and (104) may be a device of a same type as, or a different type, from the electronic device (101). According to an embodiment, all or some of operations to be executed at the electronic device (101) may be executed at one or more of the external electronic devices (102), (104), or (108). For example, if the electronic device (101) should perform a function or a service automatically, or in response to a request from a user or another device, the electronic device (101), instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device (101). The electronic device (101) may provide the outcome, with or without further processing of the outcome, as at least part of a reply to the request. To that end, a cloud computing, distributed computing, or client-server computing technology may be used, for example.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program (140)) including one or more instructions that are stored in a storage medium (e.g., internal memory (136) or external memory (138)) that is readable by a machine (e.g., the electronic device (101)). For example, a processor (e.g., the processor (120)) of the machine (e.g., the electronic device (101)) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

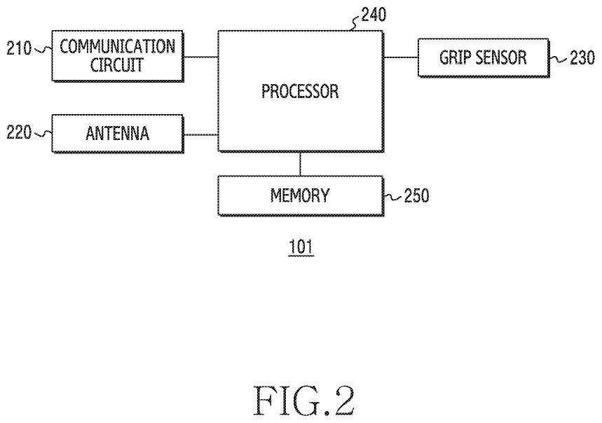

FIG. 2 is a block diagram of the electronic device according to an embodiment of the disclosure.

Referring to FIG. 2, in an embodiment, the electronic device 101 may include a communication circuit 210, an antenna 220, a grip sensor 230, a memory 250, and a processor 240.

In an embodiment, the communication circuit 210 may couple the electronic device 101 to an external electronic device. For example, the communication circuit 210 may couple the electronic device 101 to the external electronic device in a wireless or wired manner

In an embodiment, the communication circuit 210 may include at least part of the communication module 190 of FIG. 1.

In an embodiment, although not shown in FIG. 2, the electronic device 101 may include a Radio frequency (RF) front end including a transceiver for adjusting power intensity of a radio signal transmitted from the electronic device 101.

In an embodiment, the antenna 220 may transmit the radio signal to the outside or receive the radio signal from the outside. In an embodiment, the antenna 220 may be constructed as part of a housing having conductivity of the electronic device 101.

In an embodiment, the antenna 220 may perform an operation of transmitting/receiving a radio signal (e.g., a cellular radio signal), and may be an antenna capable of operating as an electrode used by the grip sensor 230 to detect capacitance. For example, the antenna 220 may perform a function for transmitting/receiving the radio signal, and may operate as an electrode for generating a line of electric force sensed by the grip sensor 230.

In an embodiment, the antenna 220 may perform an operation as an antenna for wireless charging (e.g., a coil for wireless charging), and may be an antenna capable of operating as an electrode used by the grip sensor 230 to sense a signal.

However, without being limited thereto, the grip sensor 230 may be implemented as a conductive pad independent of the antenna for transmitting/receiving the radio signal or the antenna for wireless charging.

In an embodiment, the grip sensor 230 may detect (or sense or identify) capacitance (or electrostatic capacitance) (or a variation of capacitance) which changes by an external object (e.g., a human body or an object) in proximity to or contact with the electronic device 101. In an embodiment, if the external object is in proximity to or in contact with the electronic device 101, the capacitance sensed by the grip sensor 230 may vary depending on the external object (or a dielectric constant of the external object). For example, if the human body is in proximity to or in contact with the electronic device 101, the grip sensor 230 may sense capacitance having first intensity. If an external electronic device (e.g., a pad for wireless charging) is in proximity to or in contact with the electronic device 101, the grip sensor 230 may sense capacitance having intensity less than or equal to the first intensity.

In an embodiment, the grip sensor 230 may periodically detect the capacitance. For example, the grip sensor 230 may be in an inactive state (or a standby state or an idle state or a sleep state) during a first time duration within one period, and may be in an activation state (or an active state) during a second time duration other than the first time duration. However, without being limited thereto, the grip sensor 230 may be in an always-on state without periodicity. For example, the grip sensor 230 may be persistently in the activation state while the electronic device 101 is in an on state. The grip sensor 230 may detect the capacitance in the activation state.

In an embodiment, the grip sensor 230 may generate a signal (hereinafter, referred to as a ‘sensing signal’) related to the detected capacitance (or corresponding to the detected capacitance). In an embodiment, the grip sensor 230 may transfer the generated sensing signal to the processor 240.

In an embodiment, the processor 240 may provide overall control to the electronic device 101. In an embodiment, the processor 240 may be at least partially identical or similar to the processor 120 of FIG. 1

In an embodiment, when the electronic device 101 is coupled to the external electronic device, the processor 240 may use the communication circuit 210 to maintain maximum power intensity of a radio signal to be transmitted, based on the sensing signal obtained from the grip sensor 230.

In an embodiment, the processor 240 may obtain, from the grip sensor 230, the sensing signal generated in the grip sensor 230. For example, the grip sensor 230 may be periodically activated. For another example, the grip sensor 230 may be in an always-on state without periodicity. The grip sensor 230 may detect capacitance (or a variation of capacitance) in an activation state. The grip sensor 230 may generate a sensing signal corresponding to the detected capacitance. The processor 240 may obtain the sensing signal generated from the grip sensor 230.

In an embodiment, the processor 240 may use the communication circuit 210 to detect that the electronic device 101 is coupled with an external electronic device.

In an embodiment, if the electronic device 101 is in proximity within a designated distance range to a wireless charging pad or is in contact with the wireless charging pad (or a wireless charger) (or is mounted to the wireless charging pad), the processor 240 may use the communication circuit 210 to communicatively couple the electronic device 101 with the wireless charging pad. In an embodiment, the processor 240 may use a coil for receiving power from the wireless charging pad to exchange information for communicatively coupling with the wireless charging pad, thereby communicatively coupling the electronic device 101 with the wireless charging pad. In an embodiment, the processor 240 may use a short-range wireless communication module (e.g., a Bluetooth module or a Near Field Communication (NFC) module) to exchange information for communicatively coupling with the wireless charging pad, thereby communicatively coupling the electronic device 101 with the wireless charging pad. However, a method in which the processor 240 couples the electronic device 101 with the wireless charging pad is not limited to the aforementioned example. In addition, although the wireless charging pad is exemplified, without being limited thereto, the description for the case of the wireless charging pad may also be equally applied to a case where a charger connectable with the electronic device 101 in a wired manner using a connector of the electronic device 101 is coupled with the electronic device 101.

In an embodiment, if the electronic device 101 is in contact with (or mounted or placed on) an external electronic device (e.g., dex™ of Samsung Electronics) (hereinafter, referred to as an ‘external electronic device for function sharing’) capable of allowing an external device (e.g., an external device) to perform at least some functions of the electronic device 101, the processor 240 may communicatively couple the electronic device 101 with the external electronic device for function sharing via the communication circuit 210 (e.g., the wired communication module 194 of FIG. 1).

However, the external electronic device communicatively coupled with the electronic device 101 is not limited to the aforementioned example.

In an embodiment, the processor 240 may identify whether strength of the sensing signal corresponds to a designated signal range. In an embodiment, the processor 240 may identify whether the sensing signal belongs to the designated signal range.

In an embodiment, the designated signal range comparable with the sensing signal may be a range of a sensing signal that can be obtained in a state where the electronic device 101 and the external electronic device are within a designated distance range or are in contact with each other. For example, the designated signal range comparable with the sensing signal may be a range of a sensing signal that can be generated from the grip sensor under the assumption that the electronic device 101 and the external electronic device are within the designated distance range or are in contact with each other. In an embodiment, the designated signal range may be pre-configured before an operation of obtaining the sensing signal is performed.

In an embodiment, the processor 240 may use the communication circuit 210 to maintain maximum power intensity of a radio signal to be transmitted, in response that the strength of the sensing signal corresponds to the designated range. In an embodiment, an operation of decreasing the maximum power intensity of the radio signal that can be used by the communication circuit 210 may be referred to as ‘power back off’. In an embodiment, the processor 240 may not perform the power back off, in response that the strength of the sensing signal corresponds to the designated range. For example, the processor 240 may control a transmitter to maintain the maximum power intensity of the radio signal to be transmitted, in response that the strength of the sensing signal corresponds to the designated range. For another example, the processor 240 may transfer control information related to a gain of the transmitter to the transmitter to maintain the maximum power intensity of the radio signal to be transmitted, in response that the strength of the sensing signal corresponds to the designated range. However, a method of maintaining or changing the maximum power intensity of the radio signal to be transmitted is not limited to the aforementioned example.

In an embodiment, the processor 240 may use the communication circuit 210 to decrease the maximum power intensity of the radio signal to be transmitted, in response that the strength of the sensing signal does not correspond to the designated range. In an embodiment, the processor 240 may perform the power back off, in response that the strength of the sensing signal does not correspond to the designated range.

In an embodiment, in response that the strength of the sensing signal does not correspond to the designated range, the processor 240 may use the communication circuit 210 to allow the maximum power intensity of the radio signal to be transmitted to be is less than or equal to power intensity that satisfies a designated (or standard) Specific Absorption Rate (SAR)

In an embodiment, when the electronic device 101 is coupled to the external electronic device, based on the sensing signal obtained from the grip sensor 230, the communication circuit 210 may be used to maintain the maximum power intensity of the radio signal to be transmitted, thereby avoiding deterioration of communication performance.

In an embodiment, when the electronic device 101 is coupled to the external electronic device, based on whether the external electronic device is the designated electronic device 101, the processor 240 may use a communication signal to perform an operation of maintaining the maximum power intensity of the radio signal to be transmitted.

In an embodiment, based on identifying the external electronic device coupled to the electronic device 101, the processor 240 may perform the operation of maintaining the maximum power intensity of the radio signal.

In an embodiment, the processor 240 may identify the external electronic device during the electronic device 101 is coupled with the external electronic device or after the electronic device 101 is coupled with the external electronic device. For example, the processor 240 may obtain Identity (ID) information of the external electronic device from the external electronic device during the electronic device 101 is coupled with the external electronic device. The processor 240 may identify, for example, the external electronic device (or a type of the external electronic device), based on the obtained ID information.

In an embodiment, the processor 240 may identify whether the identified external electronic device is the designated external electronic device. In an embodiment, while performing a function in a state where the electronic device 101 is coupled with the external electronic device, the processor 240 may designate (or pre-configure) an external electronic device having a relatively small possibility that a human body is located within a designated distance range from the electronic device 101 or is in contact therewith as the designated external electronic device. For example, the processor 240 may designate a device which performs a function in a state where the electronic device 101 is mounted (or placed) on the external electronic device, such as a wireless charging pad or an external electronic device for function sharing, as the designated external electronic device. For another example, the processor 240 may not designate an external electronic device having a relatively high possibility that a human body is located within a designated distance range from the electronic device 101 or is in contact therewith in a state where the electronic device 101 is coupled with the external electronic device, such as an earphone, as the designated external electronic device. However, a method of designating the external electronic device is not limited to the aforementioned example.

In an embodiment, when the identified external electronic device is the designated external electronic device, the processor 240 may identify whether strength of a sensing signal obtained from the grip sensor 230 corresponds to a designated signal range. In an embodiment, the processor 240 may use the communication circuit 210 to maintain maximum power intensity of a radio signal to be transmitted, in response that the strength of the sensing signal corresponds to the designated signal range.

In an embodiment, based on the designated signal range corresponding to the external electronic device coupled to the electronic device 101, the processor 240 may use a communication signal to perform an operation of maintaining the maximum power intensity of the radio signal to be transmitted.

In an embodiment, if it is identified that the external electronic device coupled to the electronic device 101 is not the designated external electronic device, the processor 240 may identify whether the strength of the sensing signal obtained from the grip sensor 230 is greater than or equal to the designated signal strength.

In an embodiment, based on whether the strength of the sensing signal obtained from the grip sensor 230 is greater than or equal to the designated signal strength, the processor 240 may decrease the maximum power intensity of the radio signal. For example, in response that the strength of the sensing signal obtained from the grip sensor 230 is greater than or equal to the designated signal strength, the processor 240 may decrease the maximum power intensity of the radio signal. For another example, in response that the strength of the sensing signal obtained from the grip sensor 230 is less than the designated signal strength, the processor 240 may maintain the maximum power intensity of the radio signal.

In an embodiment, based on the designated signal range corresponding to the external electronic device, the processor 240 may perform an operation of maintaining the maximum power intensity of the radio signal.

In an embodiment, the electronic device 240 may obtain ID information of the external electronic device from the external electronic device while the electronic device 101 is coupled with the external electronic device. In an embodiment, the processor 240 may identify the external electronic device, based on the obtained ID information of the external electronic device.

In an embodiment, the processor 240 may identify the designated signal range corresponding to the identified external electronic device. In an embodiment, the designated signal range may be designated (or pre-configured) differently according to the external electronic device. For example, the designated first signal range may be a range of a sensing signal that can be generated from the grip sensor under the assumption that the electronic device 101 and the external electronic device are within the designated distance range or are in contact with each other. For another example, a designated second signal range may be a range of a sensing signal that can be generated from the grip sensor 230, under the assumption that the electronic device 101 and a second external electronic device different from the first external electronic device are within a designated distance range or are in contact with each other. In an embodiment, the designated signal range corresponding to the external electronic device may be stored in the memory 250. For example, a plurality of designated signal ranges respectively corresponding to a plurality of external electronic devices may be stored in the memory 250.

In an embodiment, the processor 240 may identify whether the strength of the sensing signal corresponds to the designated signal range corresponding to the external electronic device coupled with the electronic device 101. In an embodiment, the processor 240 may use the communication circuit 210 to maintain the maximum power intensity of the radio signal to be transmitted, in response that the strength of the sensing signal corresponds to the designated signal range corresponding to the external electronic device.

In an embodiment, the processor 240 may perform an operation of maintaining or decreasing the maximum power intensity of the radio signal to be transmitted based on the sensing signal in a state where the electronic device 101 is not coupled with the external electronic device.

In an embodiment, the processor 240 may obtain the sensing signal in a state where the electronic device 101 is not coupled with the external electronic device.

In an embodiment, the processor 240 may identify whether the strength of the sensing signal corresponds to the designated signal range.

In an embodiment, the designated signal range may be a range of a sensing signal that can be generated from the grip sensor 230 (hereinafter, referred to as a ‘designated third signal range) when the external electronic device assumes that the electronic device 101 and the external electronic device are within the designated distance range or are in contact with each other.

In an embodiment, in response that the strength of the sensing signal corresponds to the designated third signal range, the processor 240 may maintain the maximum power intensity of the radio signal to be transmitted.

In an embodiment, in response that the strength of the sensing signal does not correspond to the designated third signal range, the processor 240 may decrease the maximum power intensity of the radio signal to be transmitted.

In an embodiment, if the strength of the sensing signal corresponds to the designated third signal range, the maximum power intensity of the radio signal to be transmitted is maintained to avoid deterioration of communication performance of the electronic device 101.

In an embodiment, the designated signal range may be a range of a sensing signal that can be generated from the grip sensor 230 (hereinafter, referred to as a ‘designated fourth signal range’), under the assumption that the electronic device 101 and a human body are within a designated distance range or are in contact with each other.

In an embodiment, the processor 240 may decrease the maximum power intensity of the radio signal to be transmitted, in response that the strength of the sensing signal corresponds to the designated fourth signal range.

In an embodiment, the processor 240 may maintain the maximum power intensity of the radio signal to be transmitted, in response that the strength of the sensing signal corresponds to the designated fourth signal range.

In an embodiment, if the strength of the sensing signal corresponds to the designated fourth signal range, the maximum power intensity of the radio signal to be transmitted may be decreased to satisfy a reference value for an SAR specified in each country.

In an embodiment, the memory 250 may be at least partially identical or similar to the memory 130 of FIG. 1.

In an embodiment, the memory 250 may store a plurality of designated signal ranges respectively corresponding to a plurality of external electronic devices.

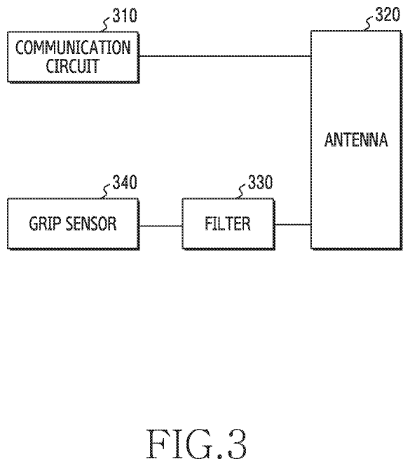

FIG. 3 is a drawing illustrating a grip sensor and a structure of an electronic device related to the grip sensor according to an embodiment of the disclosure.

Referring to FIG. 3, in an embodiment, a communication circuit 310 may wirelessly couple the electronic device 101 to an external electronic device. In an embodiment, the communication circuit 310 may be included in the communication module of FIG. 1. For example, the communication circuit 310 may be a wireless communication module (e.g., a cellular communication module, a short-range communication module, or a broadcast communication module).

In an embodiment, an antenna 320 may transmit a radio signal to the outside or may receive the radio signal from the outside. In an embodiment, the antenna 320 may be constructed as part of a housing having conductivity of the electronic device 101.

In an embodiment, the antenna 320 may perform an operation of transmitting/receiving a radio signal (e.g., a cellular radio signal), and may be an antenna capable of operating as an electrode used by the grip sensor 340 to detect capacitance. For example, the antenna 320 may perform a function for transmitting/receiving the radio signal, and may operate as an electrode for generating a line of electric force sensed by the grip sensor 340.

In an embodiment, a filter 330 may be configured such that a radio signal transmitted by the communication circuit 310 is not detected by the grip sensor 340. For example, a magnitude of frequency of the radio signal transmitted by the communication circuit 310 may be greater than a magnitude of frequency of a signal (e.g., current generated in the antenna 320 when the external electronic device is located within a designated distance from the electronic device 101 or is in contact with the electronic device 101) corresponding to capacitance. In an embodiment, the filter 330 may prevent the radio signal transmitted from the communication circuit 340 from being transferred to the grip sensor 340, and may be a Low Pass Filter (LPF) which transfers a signal corresponding to capacitance to the grip sensor 340. In an embodiment, the filter 330 may prevent the radio signal transmitted by the communication circuit 310 from being transferred to the grip sensor 340, and may be an inductor having inductance for transferring a signal corresponding to capacitance to the grip sensor 340. However, the filter 330 may prevent the radio signal transmitted by the communication circuit 310 from being transferred to the grip sensor 340 in addition to the aforementioned LPF or inductor, and may include all configurations for transferring the signal corresponding to capacitance to the grip sensor 340.

In an embodiment, the grip sensor 340 may be at least partially identical or similar to the grip sensor 230 of FIG. 2. In an embodiment, the communication circuit 320 may be at least partially identical or similar to the communication circuit 190 of FIG. 1.

Although it is exemplified in FIG. 3 that an electrode of the grip sensor 340 is implemented as the antenna 320 for transmitting/receiving a radio signal, the disclosure is not limited thereto. For example, the electrode of the grip sensor 340 may be implemented as a coil for wireless charging. For another example, the grip sensor 340 may be implemented as a conductive pad independent of the antenna 320 and the coil for wireless changing.

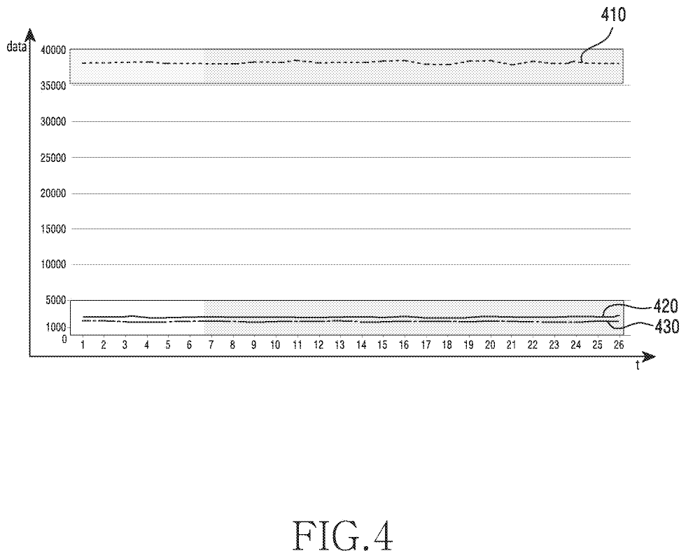

FIG. 4 is a diagram illustrating a sensing signal obtained depending on a human body or an external electronic device according to an embodiment of the disclosure.

Referring to FIG. 4, in an embodiment, when external objects are in proximity within a designated distance range to the electronic device 101 or are in contact with the electronic device 101, lines may indicate strength of sensing signals generated by the grip sensor 230 according to a time t.

For example, if a human body is in proximity within the designated distance range to the electronic device 101 or is in contact with electronic device 101, the grip sensor 230 may generate a sensing signal indicating, for example, about 35000 to 40000, similarly to a line 410.

For another example, if external electronic devices are in proximity within the designated distance range to the electronic device 101 or are in contact with the electronic device 101, the grip sensor 230 may generate a sensing signal indicating, for example, about 1000 to 5000, similarly to lines 420 and 430. If a first external electronic device is in proximity within the designated distance range to the electronic device 101 or is in contact with the electronic device 101, the line 420 may be the sensing signal generated by the grip sensor 230. If a second electronic device different from the first external electronic device is in proximity within the designated distance range to the electronic device 101, the line 430 may be the sensing signal generated by the grip sensor 230.

In an embodiment, as shown in FIG. 4, if the human body or the external electronic device is in proximity within the designated distance range to the electronic device 101, the grip sensor 230 may generate a different sensing signal.

In an embodiment, as shown in FIG. 4, if the external electronic device is in proximity within the designated distance range to the electronic device 101, the grip sensor 230 may generate a different sensing signal depending on the external electronic device.

An electronic device according to various embodiments of the disclosure may include a communication circuit, a grip sensor, and at least one processor. The at least one processor may be configured to obtain a sensing signal generated in the grip sensor, detect that the electronic device is coupled to an external electronic device via the communication circuit, identify whether strength of the sensing signal corresponds to a designated signal range, upon detecting that the electronic device is coupled to the external electronic device, and maintain maximum power intensity of a radio signal to be transmitted via the communication circuit, in response that the strength of the sensing signal corresponds to the designated signal range.

In various embodiments, the at least one processor may be configured to decrease the maximum power intensity of the radio signal to be transmitted via the communication circuit, in response that the strength of the sensing signal does not correspond to the designated signal range.

In various embodiments, the designated signal range may be designated based on the strength of the sensing signal that can be generated by the grip sensor in a state where the electronic device is located within a designate distance range with respect to the external electronic device or is in contact with the external electronic device.

In various embodiments, the at least one processor may be configured to identify the designated signal range corresponding to the external electronic device among a plurality of designated signal ranges stored in a memory of the electronic device and respectively corresponding to a plurality of external electronic devices, based on an Identity (ID) of the external electronic device.

In various embodiments, the at least one processor may be configured to identify whether the external electronic device is a designated external electronic device, and identify whether the strength of the sensing signal corresponds to the designated signal range, in response to identifying that the external electronic device is the designated external electronic device.

In various embodiments, the designated external electronic device may be a device capable of performing a function in a state where the electronic device is mounted to the designated external electronic device.

In various embodiments, the designated external electronic device may include a wireless charging pad or a device used when the electronic device allows an external device to perform at least part of a function of the electronic device.

In various embodiments, the electronic device may further include an antenna which constitutes part of a housing of the electronic device and transmits the radio signal, and a filter which prevents the radio signal from being transferred to the grip sensor. The grip sensor may receive a signal for generating the sensing signal from the antenna.

In various embodiments, the at least one processor may be configured to identify that the coupling between the electronic device and the external electronic device is released, and decrease the maximum power intensity of the radio signal, in response to identifying that the strength of the sensing signal is greater than or equal to designated signal strength.

An electronic device according to various embodiments of the disclosure may include a communication circuit, a grip sensor, and at least one processor. The at least one processor may be configured to obtain a sensing signal generated in a grip sensor, identify whether strength of the sensing signal corresponds to a designated signal range, and maintain maximum power intensity of a radio signal to be transmitted via the communication circuit, in response that the strength of the sensing signal corresponds to the designated signal range.

In various embodiments, the at least one processor may be configured to decrease the maximum power intensity of the radio signal to be transmitted via the communication circuit, in response that the strength of the sensing signal does not correspond to the designated signal range.

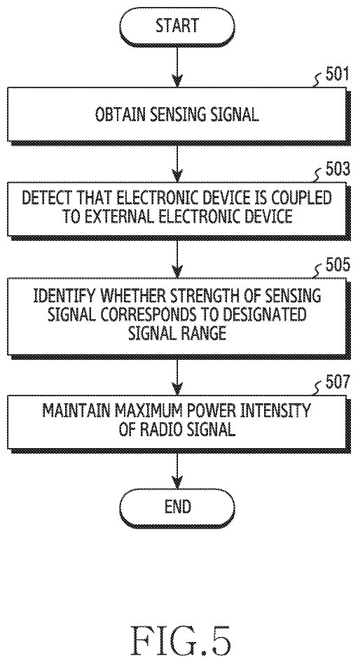

FIG. 5 is a flowchart illustrating a method for controlling power back off using a grip sensor according to an embodiment of the disclosure.

Referring to FIG. 5, in operation 501, in an embodiment, the processor 240 may obtain, from the grip sensor 230, a sensing signal generated in the grip sensor 230. For example, the grip sensor 230 may be periodically activated. For another example, the grip sensor 230 may be in an always-on state without periodicity. The grip sensor 230 may detect capacitance (or a variation of capacitance) in an activation state. The grip sensor 230 may generate a sensing signal corresponding to the detected capacitance. The processor 240 may obtain the sensing signal generated from the grip sensor 230.

In operation 503, in an embodiment, the processor 240 may use the communication circuit 210 to detect that the electronic device 101 is coupled with an external electronic device.

In an embodiment, if the electronic device 101 is in proximity within a designated distance range to a wireless charging pad or is in contact with the wireless charging pad (or a wireless charger) (or is mounted to the wireless charging pad), the processor 240 may use the communication circuit 210 to communicatively couple the electronic device 101 with the wireless charging pad. In an embodiment, the processor 240 may use a coil for receiving power from the wireless charging pad to exchange information for communicatively coupling with the wireless charging pad, thereby communicatively coupling the electronic device 101 with the wireless charging pad. In an embodiment, the processor 240 may use a short-range wireless communication module (e.g., a Bluetooth module or a Near Field Communication (NFC) module) to exchange information for communicatively coupling with the wireless charging pad, thereby communicatively coupling the electronic device 101 with the wireless charging pad. However, a method in which the processor 240 couples the electronic device 101 with the wireless charging pad is not limited to the aforementioned example. In addition, although the wireless charging pad is exemplified, without being limited thereto, the description for the case of the wireless charging pad may also be equally applied to a case where a charger connectable with the electronic device 101 in a wired manner using a connector of the electronic device 101 is coupled with the electronic device 101.

In an embodiment, if the electronic device 101 is in contact with (or mounted or placed to) an external electronic device for function sharing, the processor 240 may use the communication circuit 210 (e.g., a wired communication module) to communicatively couple the electronic device 101 with the external electronic device for function sharing.

However, the external electronic device communicatively coupled with the electronic device 101 is not limited to the aforementioned example.

In operation 505, in an embodiment, the processor 240 may identify whether strength of the sensing signal corresponds to a designated signal range. In an embodiment, the processor 240 may identify whether the sensing signal belongs to the designated signal range.

In an embodiment, the designated signal range comparable with the sensing signal may be a range of a sensing signal that can be obtained in a state where the electronic device 101 and the external electronic device are within a designated distance range or are in contact with each other. For example, the designated signal range comparable with the sensing signal may be a range of a sensing signal that can be generated from the grip sensor under the assumption that the electronic device 101 and the external electronic device are within the designated distance range or are in contact with each other. In an embodiment, the designated signal range may be pre-configured before an operation of obtaining the sensing signal is performed.

In operation 507, in an embodiment, the processor 240 may maintain maximum power intensity of a radio signal, based on whether the strength of the sensing signal corresponds to the designated range.

In an embodiment, the processor 240 may use the communication circuit 210 to maintain maximum power intensity of a radio signal to be transmitted, in response that the strength of the sensing signal corresponds to the designated range. In an embodiment, an operation of decreasing the maximum power intensity of the radio signal that can be used by the communication circuit 210 may be referred to as ‘power back off’. In an embodiment, the processor 240 may not perform the power back off, in response that the strength of the sensing signal corresponds to the designated range. For example, the processor 240 may control a transmitter to maintain the maximum power intensity of the radio signal to be transmitted, in response that the strength of the sensing signal corresponds to the designated range. For another example, the processor 240 may transfer control information related to a gain of the transmitter to the transmitter to maintain the maximum power intensity of the radio signal to be transmitted, in response that the strength of the sensing signal corresponds to the designated range. However, a method of maintaining or changing the maximum power intensity of the radio signal to be transmitted is not limited to the aforementioned example.

In an embodiment, the processor 240 may use the communication circuit 210 to decrease the maximum power intensity of the radio signal to be transmitted, in response that the strength of the sensing signal does not correspond to the designated range. In an embodiment, the processor 240 may perform the power back off, in response that the strength of the sensing signal does not correspond to the designated range.

In an embodiment, in response that the strength of the sensing signal does not correspond to the designated range, the processor 240 may use the communication circuit 210 to allow the maximum power intensity of the radio signal to be transmitted to be less than or equal to power intensity that satisfies a designated (or standard) Specific Absorption Rate (SAR)

In an embodiment, an operation of decreasing the maximum power intensity of the radio signal to be transmitted by using the communication circuit 210 may be referred to as ‘power back off’.

In an embodiment, when the electronic device 101 is coupled to the external electronic device, based on the sensing signal obtained from the grip sensor 230, the communication circuit 210 may be used to maintain the maximum power intensity of the radio signal to be transmitted, thereby maintaining (or improving) communication performance.

Although not shown in FIG. 5, in an embodiment, upon identifying that the strength of the sensing signal is greater than or equal to the designated signal strength in a state where the electronic device 101 is not coupled with the external electronic device, the processor 240 may use the communication circuit 210 to decrease the maximum power intensity of the radio signal to be transmitted. For example, the processor may identify that coupling between the electronic device 101 and the external electronic device is released. In response to identifying that the coupling between the electronic device 101 and the external electronic device is released and the strength of the sensing signal is greater than or equal to the designated signal strength, the processor may use the communication circuit 210 to decrease the maximum power intensity of the radio signal to be transmitted.

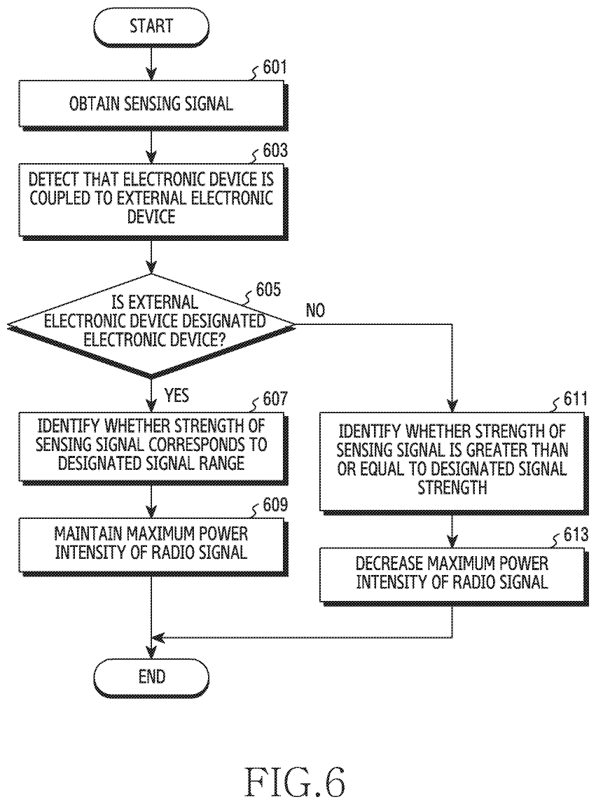

FIG. 6 is a flowchart illustrating a method for controlling power back off using a grip sensor, based on an external electronic device coupled to an electronic device, according to an embodiment of the disclosure.

Referring to FIG. 6, in operation 601, in an embodiment, the processor 240 may obtain, from the grip sensor 230, a sensing signal generated in the grip sensor 230.

In an embodiment, operation 601 is at least partially identical or similar to the operation 501 of FIG. 5, and thus detailed descriptions thereof will be omitted.

In operation 603, in an embodiment, the processor 240 may use the communication circuit 210 to detect that the electronic device 101 is coupled with an external electronic device.

In an embodiment, the processor 240 may identify the external electronic device during the electronic device 101 is coupled with the external electronic device or after the electronic device 101 is coupled with the external electronic device. For example, the processor 240 may obtain Identity (ID) information of the external electronic device from the external electronic device during the electronic device 101 is coupled with the external electronic device. The processor 240 may identify, for example, the external electronic device (or a type of the external electronic device), based on the obtained ID information.

In operation 605, in an embodiment, the processor 240 may identify whether the identified external electronic device is the designated external electronic device. In an embodiment, while performing a function in a state where the electronic device 101 is coupled with the external electronic device, the processor 240 may designate (or pre-configure) an external electronic device having a relatively small possibility that a human body is located within a designated distance range from the electronic device 101 or is in contact therewith as the designated external electronic device. For example, the processor 240 may designate a device which performs a function in a state where the electronic device 101 is mounted (or placed) on the external electronic device, such as a wireless charging pad or an external electronic device for function sharing, as the designated external electronic device. For another example, the processor 240 may not designate an external electronic device having a relatively high possibility that a human body is located within a designated distance range from the electronic device 101 or is in contact therewith in a state where the electronic device 101 is coupled with the external electronic device, such as an earphone, as the designated external electronic device. However, a method of designating the external electronic device is not limited to the aforementioned example.

In operation 607, if it is identified in operation 605 that the external electronic device is the designated external electronic device, in an embodiment, the processor 240 may identify whether strength of a sensing signal obtained from the grip sensor 230 corresponds to a designated signal range.

Operation 607 is at least partially identical or similar to the operation 505 of FIG. 5, and thus detailed descriptions thereof will be omitted

In operation 609, in an embodiment, the processor 240 may use the communication circuit 210 to maintain maximum power intensity of a radio signal to be transmitted, in response that the strength of the sensing signal corresponds to the designated signal range.

Operation 609 is at least partially identical or similar to the operation 507 of FIG. 5, and thus detailed descriptions thereof will be omitted

In operation 611, if it is identified in operation 605 that the external electronic device is not the designated external electronic device, in an embodiment, the processor 240 may identify whether the strength of the sensing signal obtained from the grip sensor 230 is greater than or equal to the designated signal strength.

In operation 613, in an embodiment, based on whether the strength of the sensing signal obtained from the grip sensor 230 is greater than or equal to the designated signal strength, the processor 240 may decrease the maximum power intensity of the radio signal. For example, in response that the strength of the sensing signal obtained from the grip sensor 230 is greater than or equal to the designated signal strength, the processor 240 may decrease the maximum power intensity of the radio signal. For another example, in response that the strength of the sensing signal obtained from the grip sensor 230 is less than the designated signal strength, the processor 240 may maintain the maximum power intensity of the radio signal.

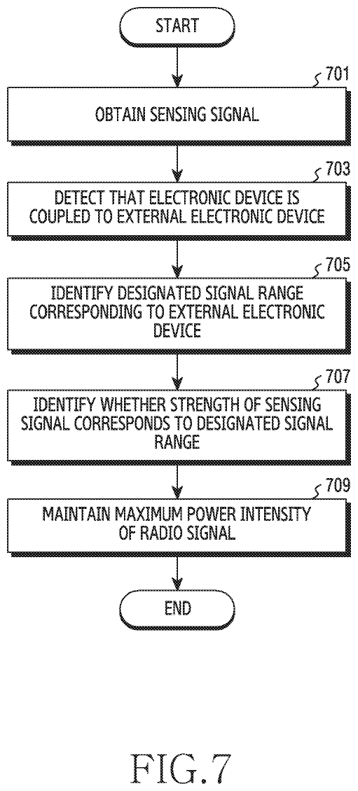

FIG. 7 is a flowchart illustrating a method for controlling power back off using a grip sensor, based on a designated signal range corresponding to an external electronic device, according to an embodiment of the disclosure.

Referring to FIG. 7, in operation 701, in an embodiment, the processor 240 may obtain, from the grip sensor 230, a sensing signal generated in the grip sensor 230.

In an embodiment, operation 701 is at least partially identical or similar to the operation 501 of FIG. 5, and thus detailed descriptions thereof will be omitted.

In operation 703, in an embodiment, the processor 240 may use the communication circuit 210 to detect that the electronic device 101 is coupled with an external electronic device.

In an embodiment, operation 703 is at least partially identical or similar to the operation 503 of FIG. 5, and thus detailed descriptions thereof will be omitted.

In operation 705, in an embodiment, the processor 240 may identify a designated signal range corresponding to an identified external electronic device. In an embodiment, the designated signal range may be designated (or pre-configured) differently according to the external electronic device. For example, a designated first signal range may be a range of a sensing signal that can be generated from the grip sensor 230 under the assumption that the electronic device 101 and a first external electronic device are within a designated distance range or are in contact with each other. For another example, a designated second signal range may be a range of a sensing signal that can be generated from the grip sensor 230, under the assumption that the electronic device 101 and a second external electronic device different from the first external electronic device are within a designated distance range or are in contact with each other. In an embodiment, the designated signal range corresponding to the external electronic device may be stored in the memory 250. For example, a plurality of designated signal ranges respectively corresponding to a plurality of external electronic devices may be stored in the memory 250.

In operation 707, in an embodiment, the processor 240 may identify whether the strength of the sensing signal corresponds to the designated signal range corresponding to the external electronic device coupled with the electronic device 101.

Operation 707 is at least partially identical or similar to the operation 505 of FIG. 5, and thus detailed descriptions thereof will be omitted.

In operation 709, in an embodiment, the processor 240 may maintain maximum power intensity of a radio signal, based on whether the strength of the sensing signal corresponds to the designated range.

Operation 709 is at least partially identical or similar to the operation 507 of FIG. 5, and thus detailed descriptions thereof will be omitted.

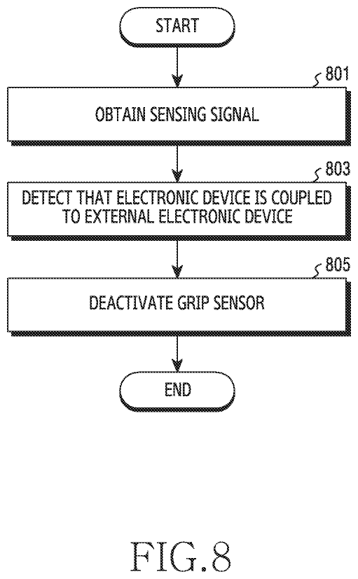

FIG. 8 is a flowchart illustrating a method for controlling an operation of a grip sensor according to an embodiment of the disclosure.

Referring to FIG. 8, in operation 801, in an embodiment, the processor 240 may obtain, from the grip sensor 230, a sensing signal generated in the grip sensor 230. For example, the grip sensor 230 may be activated periodically. For another example, the grip sensor 230 may be in an always-on state without periodicity. The grip sensor 230 may detect capacitance (or a variation of capacitance) in an activation state. The grip sensor 230 may generate a sensing signal corresponding to the detected capacitance. The processor 240 may obtain the sensing signal generated from the grip sensor 230.

In operation 803, in an embodiment, the processor 240 may use the communication circuit 210 to detect that the electronic device 101 is coupled with an external electronic device.

In an embodiment, if the electronic device 101 is in proximity within a designated distance range to a wireless charging pad or is in contact with the wireless charging pad (or a wireless charger) (or is mounted to the wireless charging pad), the processor 240 may use the communication circuit 210 to communicatively couple the electronic device 101 with the wireless charging pad.

In an embodiment, the processor 240 may detect that a charger connectable with the electronic device 101 in a wired manner using a connector of the electronic device 101 is coupled with the electronic device 101.

In an embodiment, if the electronic device 101 is in contact with (or mounted or placed to) an external electronic device for function sharing, the processor 240 may use the communication circuit 210 (e.g., a wired communication module) to communicatively couple the electronic device 101 with the external electronic device for function sharing.

However, the external electronic device communicatively coupled with the electronic device 101 is not limited to the aforementioned example.

In operation 805, in an embodiment, the processor 240 may deactivate the grip sensor 230, in response to detecting that the electronic device 101 is coupled with the external electronic device.

In an embodiment, if the grip sensor 230 is inactive, the processor 240 may not be able to receive the sensing signal generated in the grip sensor 230 via the grip sensor 230. If the sensing signal is not received from the grip sensor 230, the processor 240 may maintain maximum power intensity of a radio signal. If the sensing signal is not received from the grip sensor 230, the processor 240 may not perform a power back off operation.

Although not shown in FIG. 8, in an embodiment, if coupling between the electronic device 101 and the external electronic device is released, the processor 240 may activate the grip sensor 230 which is in an inactive state.

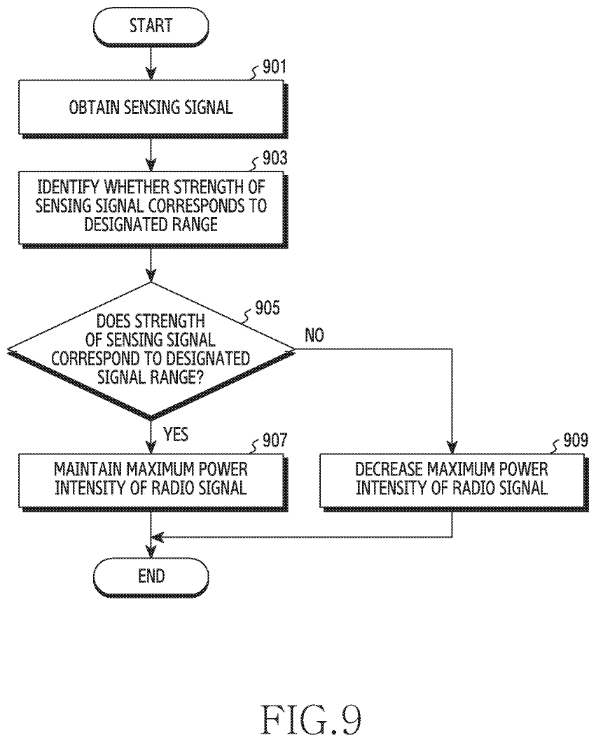

FIG. 9 is a flowchart illustrating a method for controlling power back off using a grip sensor based on a proximity or contact of an external object according to an embodiment of the disclosure. In an embodiment, FIG. 9 may be a drawing illustrating a method for controlling power back off using the grip sensor 230 irrespective of coupling of the electronic device 101 and an external electronic device.

Referring to FIG. 9, in operation 901, in an embodiment, the processor 240 may obtain, from the grip sensor 230, a sensing signal generated in the grip sensor 230.

Operation 901 is at least partially identical or similar to the operation 501 of FIG. 5, and thus detailed descriptions thereof will be omitted.

In operation 903, in an embodiment, the processor 240 may identify whether strength of the sensing signal corresponds to a designated signal range.

In an embodiment, the designated signal range may be a range of a sensing signal that can be generated from the grip sensor 230 (hereinafter, referred to as a ‘designated third signal range’), when an external electronic device (e.g., a wireless charging pad or an external electronic device for function sharing) assumes that the electronic device 101 and the external electronic device are within a designated distance range or are in contact with each other.

In operation 905, upon identifying that the strength of the sensing signal corresponds to the designated signal range (e.g., the designated third signal range), processing to operation 907, in an embodiment, the processor 240 may decrease maximum power intensity of a radio signal to be transmitted.

Operation 907 is at least partially identical or similar to the operation 609 of FIG. 6, and thus detailed descriptions thereof will be omitted.

In operation 905, upon identifying that the strength of the sensing signal does not correspond to the designated signal range (e.g., the designated third signal range), processing to operation 909, in an embodiment, the processor 240 may decrease the maximum power intensity of the radio signal to be transmitted.

Operation 909 is at least partially identical or similar to the operation 613 of FIG. 6, and thus detailed descriptions thereof will be omitted.

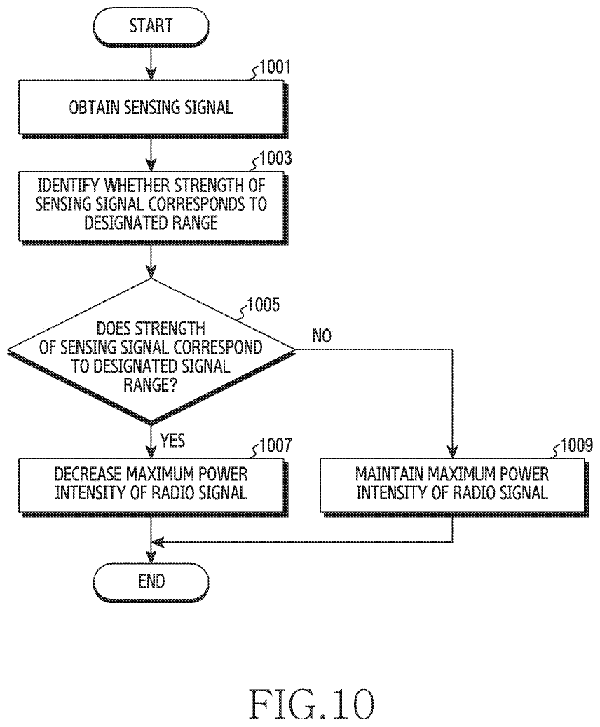

FIG. 10 is a flowchart illustrating a method for controlling power back off using a grip sensor based on a proximity or contact of an external object according to an embodiment of the disclosure. In an embodiment, FIG. 10 may be a drawing illustrating a method for controlling power back off using the grip sensor 230 irrespective of coupling of the electronic device 101 and an external electronic device.

Referring to FIG. 10, in operation 1001, in an embodiment, the processor 240 may obtain, from the grip sensor 230, a sensing signal generated in the grip sensor 230.

The operation 1001 is at least partially identical or similar to the operation 501 of FIG. 5, and thus detailed descriptions thereof will be omitted.

In operation 1003, in an embodiment, the processor 240 may identify whether strength of the sensing signal corresponds to a designated signal range.

In an embodiment, the designated signal range may be a range of a sensing signal that can be generated from the grip sensor 230 (hereinafter, referred to as a ‘designated fourth signal range’), under the assumption that the electronic device 101 and a human body are within a designated distance range or are in contact with each other.

In operation 1005, upon identifying that the strength of the sensing signal corresponds to the designated signal range (e.g., the designated fourth signal range), proceeding to operation 1007, in an embodiment, the processor 240 may decrease maximum power intensity of a radio signal to be transmitted.

Operation 1007 is at least partially identical or similar to the operation 613 of FIG. 6, and thus detailed descriptions thereof will be omitted.

In operation 1005, upon identifying that the strength of the sensing signal does not correspond to the designated signal range (e.g., the designated fourth signal range), processing to operation 1009, in an embodiment, the processor 240 may maintain the maximum power intensity of the radio signal to be transmitted.

Operation 1009 is at least partially identical or similar to the operation 609 of FIG. 6, and thus detailed descriptions thereof will be omitted.

A method according to various embodiments of the disclosure may include obtaining a sensing signal generated in a grip sensor, detecting that an electronic device is coupled to an external electronic device via a communication circuit, identifying whether strength of the sensing signal corresponds to a designated signal range, upon detecting that the electronic device is coupled to the external electronic device, and maintaining maximum power intensity of a radio signal to be transmitted via the communication circuit, in response that the strength of the sensing signal corresponds to the designated signal range.

In various embodiments, the method may further include decreasing the maximum power intensity of the radio signal to be transmitted via the communication circuit, in response that the strength of the sensing signal does not correspond to the designated signal range.

In various embodiments, the designated signal range may be designated based on the strength of the sensing signal that can be generated by the grip sensor in a state where the electronic device is located within a designate distance range with respect to the external electronic device or is in contact with the external electronic device.

In various embodiments, the identifying whether strength of the sensing signal corresponds to a designated signal range may include identifying the designated signal range corresponding to the external electronic device among a plurality of designated signal ranges stored in a memory of the electronic device and respectively corresponding to a plurality of external electronic devices, based on an Identity (ID) of the external electronic device.

In various embodiments, the method may further include identifying whether the external electronic device is a designated external electronic device, and identifying whether the strength of the sensing signal corresponds to the designated signal range, in response to identifying that the external electronic device is the designated external electronic device.

In various embodiments, the designated external electronic device may be a device capable of performing a function in a state where the electronic device is mounted to the designated external electronic device.

In various embodiments, the designated external electronic device may include a wireless charging pad or a device used when the electronic device allows an external device to perform at least part of a function of the electronic device.

In various embodiments, the electronic device may further include an antenna which constitutes part of a housing of the electronic device and transmits the radio signal, and a filter which prevents the radio signal from being transferred to the grip sensor. The method may further include receiving, by the grip sensor, a signal for generating the sensing signal from the antenna.

In various embodiments, the method may further include identifying that the coupling between the electronic device and the external electronic device is released, and decreasing the maximum power intensity of the radio signal, in response to identifying that the strength of the sensing signal is greater than or equal to designated signal strength.

An electronic device according to various embodiments of the disclosure may include a communication circuit, a grip sensor, and at least one processor. The at least one processor may be configured to obtain a sensing signal generated in the grip sensor, detect that the electronic device is coupled to an external electronic device via the communication circuit, and stop an operation of the grip sensor and maintain maximum power intensity of a radio signal to be transmitted via the communication circuit, in response to detecting that the electronic device is coupled to the external electronic device.

In addition, a data structure used in the aforementioned embodiment of the disclosure may be recorded in the computer-readable recording medium through several means. The computer-readable recording medium includes a storage medium, such as a magnetic medium (e.g., a Read Only Memory (ROM), a floppy disc, a hard disc, and the like) and an optical storage medium (e.g., a Compact Disc-ROM (CD-ROM), a Digital Versatile Disc (DVD), and the like).

In an embodiment, the computer-readable recording medium may record a program for executing operations of obtaining a sensing signal generated in a grip sensor, detecting that an electronic device is coupled to an external electronic device via a communication circuit, identifying whether strength of the sensing signal corresponds to a designated signal range, upon detecting that the electronic device is coupled to the external electronic device, and maintaining maximum power intensity of a radio signal to be transmitted via the communication circuit, in response that the strength of the sensing signal corresponds to the designated signal range.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a communication circuit;
a grip sensor; and
at least one processor,
wherein the at least one processor is configured to:
obtain a sensing signal generated in the grip sensor,
detect that the electronic device is coupled to an external electronic device via the communication circuit,
identify whether a strength of the sensing signal corresponds to a designated signal range, upon detecting that the electronic device is coupled to the external electronic device, and
maintain a maximum power intensity of a radio signal to be transmitted via the communication circuit, in response that the strength of the sensing signal corresponds to the designated signal range.

2. The electronic device of claim 1, wherein the at least one processor is further configured to decrease the maximum power intensity of the radio signal to be transmitted via the communication circuit, in response that the strength of the sensing signal does not correspond to the designated signal range.

3. The electronic device of claim 1, wherein the designated signal range is designated based on the strength of the sensing signal that can be generated by the grip sensor in a state where the electronic device is located within a designate distance range with respect to the external electronic device or is in contact with the external electronic device.

4. The electronic device of claim 1, wherein the at least one processor is further configured to identify the designated signal range corresponding to the external electronic device among a plurality of designated signal ranges stored in a memory of the electronic device and respectively corresponding to a plurality of external electronic devices, based on an Identity (ID) of the external electronic device.

5. The electronic device of claim 1, wherein the at least one processor is further configured to:
identify whether the external electronic device is a designated external electronic device; and
identify whether the strength of the sensing signal corresponds to the designated signal range, in response to identifying that the external electronic device is the designated external electronic device.

6. The electronic device of claim 5, wherein the designated external electronic device includes a device capable of performing a function in a state where the electronic device is mounted to the designated external electronic device.

7. The electronic device of claim 6, wherein the designated external electronic device comprises a wireless charging pad or a device used when the electronic device allows an external device to perform at least part of a function of the electronic device.

8. The electronic device of claim 1, further comprising:
an antenna which constitutes part of a housing of the electronic device and transmits the radio signal; and
a filter for preventing the radio signal from being transferred to the grip sensor,
wherein the grip sensor receives a signal for generating the sensing signal from the antenna.

9. The electronic device of claim 1, wherein the at least one processor is further configured to:
identify that the coupling between the electronic device and the external electronic device is released; and
decrease the maximum power intensity of the radio signal, in response to identifying that the strength of the sensing signal is greater than or equal to designated signal strength.

10. A method comprising:
obtaining a sensing signal generated in a grip sensor;
detecting that an electronic device is coupled to an external electronic device via a communication circuit;
identifying whether a strength of the sensing signal corresponds to a designated signal range, upon detecting that the electronic device is coupled to the external electronic device; and
maintaining a maximum power intensity of a radio signal to be transmitted via the communication circuit, in response that the strength of the sensing signal corresponds to the designated signal range.

11. The method of claim 10, further comprising decreasing the maximum power intensity of the radio signal to be transmitted via the communication circuit, in response that the strength of the sensing signal does not correspond to the designated signal range.

12. The method of claim 10, wherein the designated signal range is designated based on the strength of the sensing signal that can be generated by the grip sensor in a state where the electronic device is located within a designate distance range with respect to the external electronic device or is in contact with the external electronic device.

13. The method of claim 10, wherein the identifying of whether the strength of the sensing signal corresponds to a designated signal range comprises identifying the designated signal range corresponding to the external electronic device among a plurality of designated signal ranges stored in a memory of the electronic device and respectively corresponding to a plurality of external electronic devices, based on an Identity (ID) of the external electronic device.

14. The method of claim 10, further comprising:
identifying whether the external electronic device is a designated external electronic device; and
identifying whether the strength of the sensing signal corresponds to the designated signal range, in response to identifying that the external electronic device is the designated external electronic device.

15. The method of claim 14, wherein the designated external electronic device is a device capable of performing a function in a state where the electronic device is mounted to the designated external electronic device.

16. The method of claim 15, wherein the designated external electronic device comprises a wireless charging pad or a device used when the electronic device allows an external device to perform at least part of a function of the electronic device.

17. The method of claim 10,
wherein the electronic device further comprises an antenna which constitutes part of a housing of the electronic device and transmits the radio signal, and a filter which prevents the radio signal from being transferred to the grip sensor, and
wherein the method further comprises receiving, by the grip sensor, a signal for generating the sensing signal from the antenna.

18. The method of claim 10, further comprising:
identifying that the coupling between the electronic device and the external electronic device is released; and
decreasing the maximum power intensity of the radio signal, in response to identifying that the strength of the sensing signal is greater than or equal to designated signal strength.

19. An electronic device comprising:
a communication circuit;
a grip sensor; and
at least one processor,
wherein the at least one processor is configured to:
obtain a sensing signal generated in a grip sensor,
identify whether a strength of the sensing signal corresponds to a designated signal range, and
maintain a maximum power intensity of a radio signal to be transmitted via the communication circuit, in response that the strength of the sensing signal corresponds to the designated signal range.

20. The electronic device of claim 19, wherein the at least one processor is further configured to decrease the maximum power intensity of the radio signal to be transmitted via the communication circuit, in response that the strength of the sensing does not correspond to the designated signal range.
